(19) United States
(12) Patent Application Publication
(10) Pub. No.: US 2017/0017986 A1
(43) Pub. Date: Jan. 19, 2017

(54) TRACKING DIGITAL DESIGN ASSET USAGE AND PERFORMANCE

(71) Applicant: Adobe Systems Incorporated, San Jose, CA (US)

(72) Inventors: Craig M. Mathis, American Fork, UT (US); Vikas Yadav, Noida (IN)

(21) Appl. No.: 14/801,638

(22) Filed: Jul. 16, 2015

(51) Int. Cl. G06Q 30/02; G06F 17/30

(52) U.S. Cl. CPC G06Q 30/0242; G06F 17/30876

(57) ABSTRACT

Methods and systems for analyzing usage and performance of digital design assets for asset selection. In particular, one or more embodiments maintain a digital design asset repository containing a plurality of digital design assets available for use in marketing campaigns. One or more embodiments assign asset identifiers to the digital design assets. One or more embodiments then track usage of and interactions with a first digital design asset in a plurality of marketing campaigns. One or more embodiments aggregate analytics data for the first digital design asset based on the tracked usage and interactions, and provide the aggregated analytics data with the first digital design asset in the digital design asset repository.

### BACKGROUND

1. Technical Field

One or more embodiments relate generally to systems and methods for tracking usage and performance of digital design assets. More specifically, one or more embodiments relate to systems and methods of tracking usage and performance of individual digital design assets used in marketing campaigns.

2. Background and Relevant Art

Analytics companies track user interactions to generate analytics reports. Analytics reports detail user interactions with advertisements, user visits to websites, user purchases, and other interactions. The data gathered by analytics reports can provide valuable insights. For example, analytic reports can help entities learn which marketing campaigns are successful and which campaigns are not successful. Analytic reports can also help entities learn where and when advertising can be most effective for converting potential customers into customers.

When determining whether a marketing campaign is successful, analytics companies traditionally rely on analytic reports that describe a usage and performance of the campaigns themselves. For example, analytic reports describing marketing campaigns can include indications of where and how often the campaigns were used, how many users interacted with the campaigns, how many conversions resulted from the campaigns, demographics associated with interactions/conversions, etc. While analytic reports that describe the performance of marketing campaigns are useful in determining how a specific campaign performs, such reports do not provide information of individual components that can be used in multiple marketing campaigns. Thus, it is often difficult for advertisers and commercial entities to determine how well individual creative assets are performing.

Additionally, because traditional methods of gathering analytics data for marketing campaigns do not determine usage and performance of individual components in the campaigns, creators of the components are often unaware of the use or performance of their own creations. For example, if an asset is used in a successful marketing campaign, the creator of the asset may never know exactly how well the asset performed or if the asset was responsible for the campaign's success. Furthermore, the lack of information about the asset may make it difficult for the creator to know how to improve the asset or how to create new successful assets

These and other disadvantages may exist with respect to conventional marketing analytics tracking techniques.

### SUMMARY

One or more embodiments provide benefits and/or solve one or more of the foregoing or other problems in the art with systems and methods for tracking usage and performance of digital design assets. For instance, one or more embodiments of the systems and methods provide analytics data for usage and performance of digital design assets in a plurality of marketing campaigns. In particular, one or more embodiments of the systems and methods track usage of digital design assets in a plurality of marketing campaigns using asset identifiers assigned to the digital design assets. One or more embodiments also track interactions by one or more users with digital design assets used in a plurality of marketing campaigns. Based on the tracked usage of and interactions with the digital design assets, the systems and methods provide aggregated analytics data with the digital design assets in a digital design asset repository.

By tracking usage and performance of the digital design assets in connection with a plurality of marketing campaigns, the systems and methods provide data that provides a better understanding of the effectiveness of their marketing campaigns. Specifically, providing the aggregated analytics data with the digital design assets in the digital design asset repository allows content creators, advertisers, and other entities to view where a digital design asset is being used and how well it is performing. An improved understanding of digital design assets use and performance effectiveness allows content creators and others to create and improve on future digital design assets, as well as future marketing campaigns.

Additional features and advantages of one or more embodiments of the present disclosure will be set forth in the description which follows, and in part will be obvious from the description, or may be learned by the practice of such example embodiments. The features and advantages of such embodiments may be realized and obtained by means of the instruments and combinations particularly pointed out in the appended claims. These and other features will become more fully apparent from the following description and appended claims, or may be learned by the practice of such example embodiments as set forth hereinafter.

### BRIEF DESCRIPTION OF THE DRAWINGS

In order to describe the manner in which the above recited and other advantages and features may be obtained, a more particular description of embodiments systems and methods briefly described above will be rendered by reference to specific embodiments thereof that are illustrated in the appended drawings. It should be noted that the Figures are not drawn to scale, and that elements of similar structure or function are generally represented by like reference numerals for illustrative purposes throughout the Figures. Understanding that these drawings depict only typical embodiments and are not therefore to be considered to be limiting of its scope, the systems and methods will be described and explained with additional specificity and detail through the use of the accompanying drawings in which:

FIG. 1 illustrates an environment in which an asset management system can operate in accordance with one or more embodiments;

FIG. 2 illustrates a schematic diagram of the asset management system of FIG. 1 in accordance with one or more embodiments;

FIGS. 3A-3B illustrate user interfaces displaying digital design assets in marketing campaigns in accordance with one or more embodiments;

FIGS. 4A-4B illustrate user interfaces for managing digital design assets in accordance with one or more embodiments;

FIG. 5 illustrates a flowchart of a series of acts in a method of analyzing usage of digital design assets for asset selection in accordance with one or more embodiments;

FIG. 6 illustrates a flowchart of a series of acts in a method of analyzing performance of digital design assets for asset selection in accordance with one or more embodiments; and

FIG. 7 illustrates a block diagram of an exemplary computing device in accordance with one or more embodiments.

### DETAILED DESCRIPTION

One or more embodiments of the present disclosure include an asset management system for analyzing usage and performance of digital design assets. In particular, one or more embodiments of the asset management system track usage and performance of digital design assets (e.g., digital images, video files or audio files). For instance, the asset management system can track digital design assets used in a plurality of marketing campaigns and via various marketing media or platforms. Additionally, the asset management aggregates analytics data for the digital design asset from the plurality of marketing campaigns and provides the aggregated analytics data with the digital design assets in a digital design asset repository. Thus, the asset management system can track and provide information about the individual digital design assets separately from the marketing campaigns, allowing content creators, advertisers, or other entities to have a better understanding of the performance of individual assets.

In one or more embodiments, the asset management system can maintain a digital design asset repository that includes a plurality of digital design assets. Specifically, the digital design asset repository can include digital design assets used in one or more different marketing campaigns. For example, an asset creator can generate digital design assets for use in marketing campaigns and store the digital design assets in the digital design asset repository. When delivering content in connection with a marketing campaign, the asset management system can access the digital design asset repository to select one or more of the digital design assets to deliver to client devices of potential consumers.

Additionally, one or more embodiments of the asset management system can track digital design assets by assigning asset identifiers to each of the digital design assets. In particular, the asset management system can assign unique asset identifiers to the digital design assets independently from the marketing campaigns. For example, the asset management system can embed (e.g., the content creator can embed) a unique, digital fingerprint in a particular digital design asset at the time of creation of the digital design asset. In another example, the asset management system can assign an asset identifier at a time that the asset is added to the repository, if the asset was created externally to the asset management system.

Because each asset includes a unique asset identifier, the asset management system can identify the asset identifiers for the digital design assets and the campaign identifiers for the marketing campaigns separately. For example, the asset management system can identify a marketing campaign and an asset used in the marketing campaign in separate requests to the client device (or “hits” from the client device to the asset management system). Thus, the asset management system can track how each of the digital design assets is used separately from the marketing campaigns.

In one or more embodiments, the asset management system can identify the unique asset identifiers in a marketing medium by including the asset identifiers with content delivered to the client device and associated with a tracking attribute of the marketing medium (e.g., in the HTML of a webpage). In one or more additional, or alternative, embodiments, the client device can identify the asset identifier for an asset from the metadata of the asset and send analytics data for the asset to the asset management system. In alternative embodiments, the asset management system can communicate with an application program interface (API) of the marketing medium to identify when an asset identifier is displayed in the marketing medium.

In one or more embodiments, the asset management system can aggregate analytics data for a digital design asset based on the tracked usage and performance data. Specifically, the asset management system can collect tracked usage and performance data for a digital design asset and aggregate the tracked data for providing in the digital design asset repository with the digital design asset. For example, the asset management system can track where a particular asset is being used (e.g., specific campaigns, marketing media, and geographic locations) and how the asset is performing (e.g., impressions, clicks, and conversions). A content creator and/or marketing entity can use the provided analytics data to determine how to improve existing assets, for creating new assets, and/or for determining how and where to use the assets.

Furthermore, the asset management system can track usage and performance of a plurality of digital design assets used in a single marketing campaign. Because the asset management system can assign unique identifiers to each of the digital design assets in the digital design asset repository, the asset management system can track and aggregate analytics data associated with each digital design asset individually. Even if a marketing campaign uses more than one digital design asset in the same marketing instance or via the same marketing medium, the asset management system can track usage and performance of the assets separately from each other and from the marketing campaign.

In one or more embodiments, the asset management system can determine an analytics score for each digital design asset to determine how each asset is performing. Specifically, the analytics score can be determine how impactful and useful the assets are in the respective marketing campaigns. For example, the asset management system can calculate the analytics score based on where an asset is used, as well as how users interact with the asset. The asset management system can use the analytics score for a digital design asset in determining whether to reuse the asset or whether to create new assets with similar characteristics to the digital design asset.

As used herein, a “marketing campaign” refers to a set of one or more advertisements, web pages, or other digital content sharing one or more common characteristics. Specifically, such common characteristics can include similar content (e.g., directed toward the same product, line of products, or brand), a similar theme (e.g., a particular sale, products for a particular season), or features directed toward a particular audience. For example, a marketing campaign can include one or more related advertisements that are each directed towards a single brand, product, or service. Alternatively, a marketing campaign can include advertisements that are directed towards different products or features of a line of products or services. For example, a marketer can configure a marketing campaign including a plurality of advertisements for a single product or service. Additionally, in one or more embodiments, the marketing campaign can include different types of advertisements (e.g., videos, banners, pop-ups, audio clips) that relate to a particular product or service.

As used herein, the terms “marketing medium” and “marketing media” refer to channels for delivering digital content to users in a marketing campaign. Marketing media can include, but are not limited to, websites, emails, mobile applications, social applications, and targeting recipes (e.g., a/b tests or targeted advertising experiences). Marketing content in a marketing campaign can include advertisements, branding content, content used as part of a customer experience with a commercial entity, or other content designed to attract or maintain a relationship with users.

As used herein, the term “digital design asset” or “design asset” refers to an individual content item that is used in a marketing campaign or otherwise. In particular, a digital design asset can include creative content that is designed to help advertise to and attract customers. For example, a digital design asset can include digital images, video files, audio files, or any combination thereof. To illustrate, a digital design asset can be a photograph, a computer generated graphic, a group of images, a video commercial, music, sound, and/or other such content.

As used herein “marketing content” or “electronic marketing content” refers to advertisements or other forms of digital data related to marketing that may be transmitted over a communication network. For example, marketing content can include, but is not limited to, digital media (e.g., audio, video, images), electronic documents, electronic messages, electronic advertisements, or any other digital data or combination of digital data. As an example, marketing content or advertising content can refer to a video advertisement provided to a user via a website. Other examples of marketing content or advertising content can refer to banners, overlays, pop-ups, emails, texts, audio clips, etc. Marketing content can include one or more digital design assets. For example, a particular email advertisement (e.g., an example of marketing content) can include a digital photo (an example of a digital design asset) along with other content such as hyperlinks, text, or additional digital design assets.

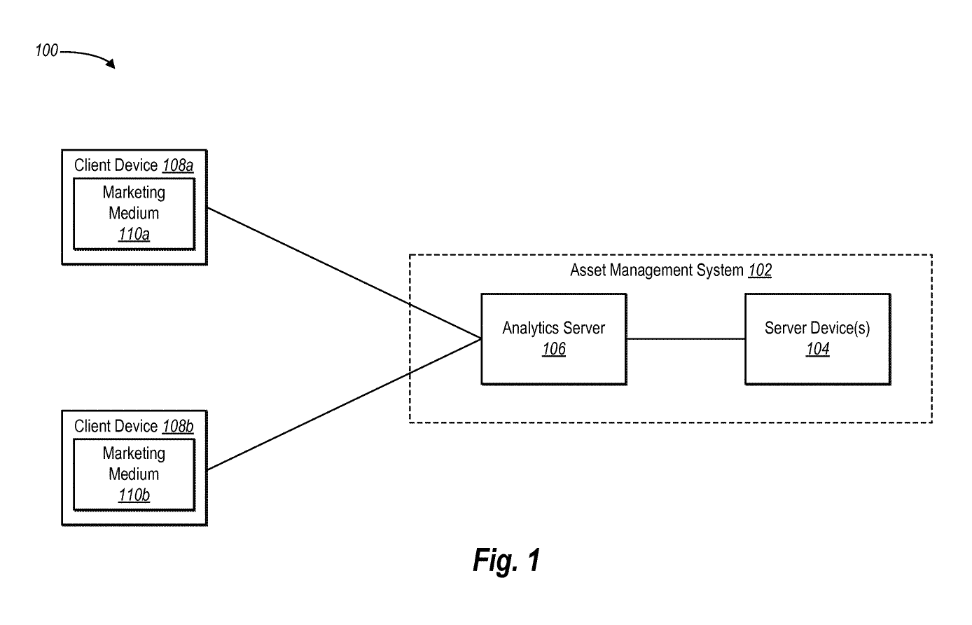

FIG. 1 illustrates one embodiment of an environment or system 100 in which an asset management system 102 can operate. In one or more embodiments, the system 100 includes server device(s) 104, an analytics server 106, and a plurality of client devices 108a, 108b. Although the system 100 of FIG. 1 is depicted as having various components, the system 100 may have any number of additional or alternative components (e.g., any number of server device(s) 104, analytics servers 106, or client devices 108a, 108b). For example, more than one component or entity in the system 100 can implement the operations of the asset management system 102 described herein. To illustrate, the server device(s) 104 and the analytics server 106 may be part of the asset management system 102. Additionally, or alternatively, the server device(s) 104 can include the analytics server 106, or vice versa.

In one or more embodiments, the asset management system 102 performs operations associated with managing marketing campaigns. Specifically, the asset management system 102 can determine which marketing campaigns to use, when to use the marketing campaigns, and how to deliver marketing content associated with selected marketing campaigns. For example, the asset management system 102 can select a marketing campaign for delivering content to one or more users. Additionally, the asset management can select one or more marketing media 110 in connection with the selected marketing campaign for delivering content to the client devices 108a, 108b of the one or more users.

In one or more embodiments, the server device(s) 104 store, manage, and provide various types of content. Specifically, the server device(s) 104 can store and manage content (e.g., marketing content) to provide to one or more users via one or more marketing media 110a, 110b at the client devices 108a, 108b. For example, the server device(s) 104 can include servers that provide content to client devices 108a, 108b over an Internet connection or other network connection. To illustrate, examples of server device(s) 104 include ad servers, media content servers, web servers, or other content servers that are able to provide marketing content to users by way of one or more marketing media 110a, 110b. According to at least some implementations, the marketing content can include one or more digital design assets (or simply “assets”), as described in more detail below.

In one or more additional, or alternative, embodiments, the server device(s) 104 provide marketing content to users in connection with one or more other content providers (not shown). Specifically, the server device(s) 104 can provide marketing content in response to a request by a client device or a content provider to deliver the marketing content to one or more client devices 108a, 108b. For example, when a content provider provides digital content (e.g., a live TV stream, webpage, or other content) to a client device, the digital content may include a space for advertisements. The client device or the content provider can send a request for the advertisement to the server device(s) 104, and the server device(s) 104 can deliver the advertisement to the client device.

In one or more embodiments, the asset management system 102 includes an analytics server 106 to collect analytics data in connection with marketing content and one or more marketing media 110a, 110b. In particular, the analytics server 106 can communicate with the server device(s) 104 and client devices 108a, 108b to collect usage and performance information associated with the marketing content. For example, the analytics server 106 can identify usage of a marketing content in a marketing campaign, and performance of the marketing content as measured by impressions and interactions with the marketing content at the client devices 108a, 108b. The asset management system 102 can provide the analytics data collected by the analytics server 106 with the marketing content on the server device(s) 104 for determining how to improve current or future marketing campaigns.

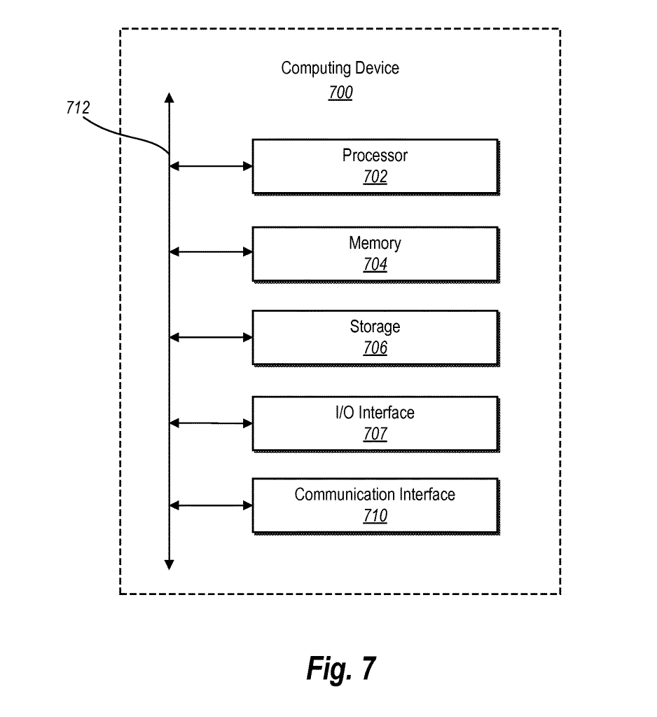

Additionally, the client devices 108a, 108b can include a computing device that allows users to access and/or store digital content for viewing on a display of the computing device or for interacting with the digital content at the computing device. For example, each of the client devices 108a, 108b can include a smartphone, tablet, desktop computer, laptop computer, or other device that is able to receive digital content from the server device(s) 104 or other content providers via a network connection. The client devices 108a, 108b may include one or more client applications that enable a user to receive and interact with marketing content from the server device(s) 104 via one or more marketing media 110. The client devices 108a, 108b may also include one or more display devices for displaying digital content. Further more, the client devices 108a, 108b can include any of the devices or features discussed below in reference to FIG. 7.

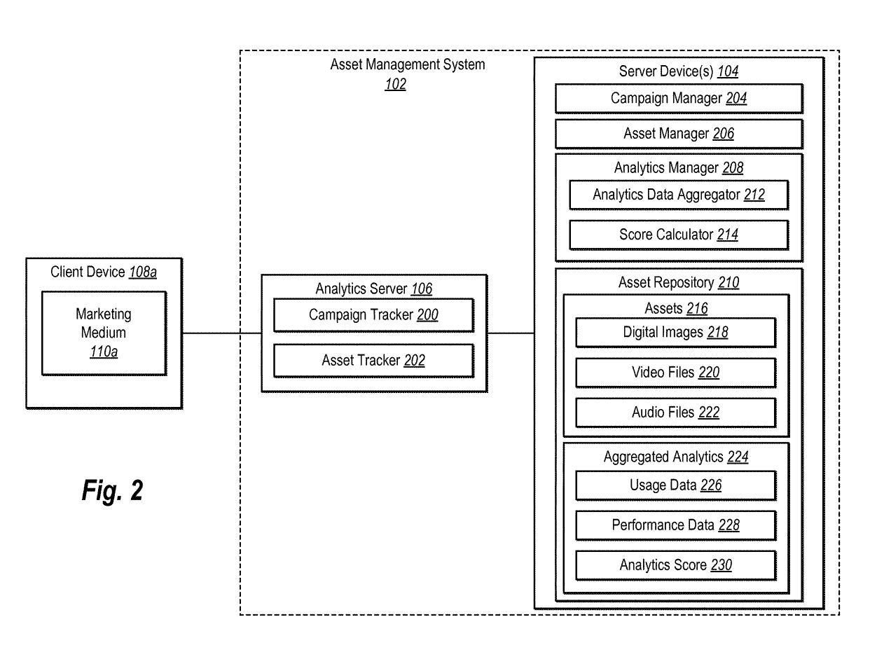

As previously mentioned, the asset management system 102 can track use of marketing content provided to one or more client devices 108a, 108b in connection with one or more marketing campaigns. FIG. 2 illustrates a detailed schematic diagram of an embodiment of the asset management system 102 of FIG. 1. As previously described, the system can include, but is not limited to, server device(s) 104, an analytics server 106, and a client device 108a. Although the system 102 of FIG. 2 is depicted as having various components, the asset management system 102 may have any number of additional or alternative components. For example, the server device(s) 104 and the analytics server 106 can be implemented on a single computing device or on multiple computing devices within the asset management system 102. Additionally, the asset management system 102 can include a plurality of server devices interacting with the analytics server 106 and the client device 108a to provide content to the client device 108a and receive analytics data from the analytics server 106. For example, the asset management system 102 can include a distributed system of server devices for providing marketing content to the client device 108a and managing received analytics data.

In one or more embodiments, each of the components 200, 202, 204, 206, 208, 210, 224 and subcomponents 212, 214, 216, 226, 228, 230 of the asset management system 102 are in communication with one another using any suitable communication technologies. Additionally, the components and subcomponents of the asset management system 102 can be in communication with the client device 108a and its subcomponents. It will be recognized that although the subcomponents of the analytics server 106 and the server device(s) 104 of the asset management system 102 are shown to be separate in FIG. 2, any of the subcomponents may be combined into fewer components, such as into a single component, or divided into more components as may serve a particular implementation. Furthermore, although the components of FIG. 2 are described in connection with the asset management system 102, at least some of the components for performing operations in conjunction with the asset management system 102 described herein may be implemented on other devices within the environment.

The components 200-230 of the asset management system 102 can include software, hardware, or both. For example, the components 200-230 of the asset management system 102 can include one or more instructions stored on a computer-readable storage medium and executable by processors of one or more computing devices (e.g., the server device(s) 104, the analytics server 106, or the client device 108a or devices in communication with the server device(s) 104 or the analytics server 106). When executed by the one or more processors, the computer-executable instructions of the asset management system 102 can cause the computing device(s) to perform the asset management methods described herein. Alternatively, the components 200-230 of the asset management system 102 can comprise hardware, such as a special purpose processing device to perform a certain function or group of functions. Additionally or alternatively, the components 200-230 of the asset management system 102 can comprise a combination of computer-executable instructions and hardware.

Furthermore, the components 200-230 of the asset management system 102 performing the functions described herein with respect to the asset management system 102 may, for example, be implemented as part of a stand-alone application, as a module of an application, as a plug-in for applications including content management applications, as a library function or functions that may be called by other applications, and/or as a cloud-computing model. Thus, the components 200-230 of the asset management system 102 may be implemented as part of a stand-alone application on a personal computing device or a mobile device. Alternatively or additionally, the components of the asset management system 102 may be implemented in any application that allows delivery of marketing content to users, including, but not limited to, applications in ADOBE MARKETING CLOUD, such as ADOBE ANALYTICS, ADOBE AUDIENCEMANAGER, ADOBE CAMPAIGN, ADOBE EXPERIENCE MANAGER, ADOBE MEDIA OPTIMIZER, ADOBE PRIMETIME, ADOBE SOCIAL, and ADOBE TARGET. “ADOBE”, “ADOBE MARKETING CLOUD”, “ADOBE ANALYTICS”, “ADOBE AUDIENCEMANAGER”, “ADOBE CAMPAIGN”, “ADOBE EXPERIENCE MANAGER”, “ADOBE PRIMETIME”, “ADOBE SOCIAL”, and “ADOBE TARGET” are registered trademarks of Adobe Systems Incorporated in the United States and/or other countries.

As previously described, the asset management system 102 can communicate with a client device 108a. In one or more embodiments, the client device 108a can include a marketing medium 110a. Specifically, the client device 108a can include a marketing medium 110a that allows the server device(s) 104 to deliver marketing content in connection with one or more marketing campaigns to the client device 108a. For example, the marketing medium 110a can include, or be part of, a client application at the client device 108a to display the marketing content to the user of the client device 108a. To illustrate, the marketing medium 110a can display marketing content via a standalone application of the client device 108a, a third party plugin of an application on the client device 108a, or a combination of applications on the client device 108a. Although not shown, the client device 108a can include a plurality of marketing media that allow the server device(s) 104 to deliver various types of marketing content for display at the client device 108a.

The asset management system 102 can also include an analytics server 106 to facilitate collecting analytics associated with a plurality of marketing campaigns. The analytics server 106 can include, but is not limited to, a campaign tracker 200 and an asset tracker 202. In one or more embodiments, the campaign tracker 200 can track usage and performance of a plurality of marketing campaigns provided to client devices, such as client device 108a. Specifically, the campaign tracker 200 can communicate with the client devices 108a to identify marketing campaigns used in connection with the marketing medium 110a on the client device 108a. Additionally, the campaign tracker 200 can communicate with the client device 108a to identify interactions by one or more users with advertisements or other marketing content associated with the marketing campaigns.

In one or more embodiments, the campaign tracker 200 can track a marketing campaign based on a campaign identifier associated with the marketing campaign. Specifically, the campaign identifier associated with the marketing campaign can be embedded in any marketing content provided to the client devices (e.g., client device 108a) via a marketing medium (e.g., marketing medium 110a). When the analytics server 106 communicates with the client device 108a, the campaign tracker 200 can identify the campaign identifier and use the campaign identifier to associate any analytics data with the corresponding marketing campaign.

More specifically, the campaign tracker 200 can track the use of specific marketing content and marketing campaigns. For example, the campaign tracker 200 can assign a marketing campaign identifier to each piece of marketing content associated with a given marketing campaign. Thus, each time marketing content associated with a marketing campaign is used, the campaign tracker 200 can track the use and associate the use with the marketing campaign. Additionally, the campaign tracker 200 can assign a marketing content identifier to each piece of marketing content to allow the tracking of specific marketing content. Thus, the campaign tracker 200 can track and provide analytics for two separate advertisements (e.g., marketing content) that are both associated with the same marketing campaign.

The analytics server 106 can also include an asset tracker 202 to track usage and performance of one or more individual design assets provided to the client device 108a. In particular, the asset tracker 202 can communicate with the client device 108a to identify design assets used in marketing content provided via the marketing medium 110a at the client device 108a. Additionally, the asset tracker 202 can communicate with the client device 108a to identify interactions by one or more users with the design assets. Although design assets provided to the client device 108a are provided in connection with one or more marketing content, the asset tracker 202 can track usage and performance of the design assets separately from the advertisements or other marketing content of the marketing campaigns to provide a better understanding of how well the design assets are performing.

In at least some embodiments, the asset tracker 202 can track a design asset based on an asset identifier associated with the design asset. Specifically, the asset identifier associated with the design asset can be embedded in the design asset provided to the client device 108a via the marketing medium 110a. When the analytics server 106 communicates with the client device 108a, the asset tracker 202 can identify the asset identifier and use the asset identifier to associate any analytics data with the corresponding design asset. As mentioned previously, because the design asset contains its own asset identifier, the asset tracker 202 can track the asset and collect analytics data for the asset separately from the marketing campaign and marketing content in which the design asset is used.

Thus, the asset tracker 202, using an assigned a unique asset ID that follows the digital design asset as it is used within different marketing solutions, can track both the usage and performance metrics associated with each digital design asset. As such, each time a digital design asset is used for marketing purposes (used in email, on a website, display advertising, targeting a/b tests, social ads, etc.) the asset tracker 202 records the usage. Each time a digital design asset is interacted with (clicked on, displayed, etc.), the asset tracker 202 can record the action.

As mentioned, the asset management system 102 can include server device(s) 104 that include, but are not limited to, a campaign manager 204, an asset manager 206, an analytics manager 208, and a digital design asset repository (or simply “asset repository” 210). In one or more embodiments, the server device(s) 104 can include a campaign manager 204 to facilitate selection of marketing campaigns for delivering marketing content to users. In particular, the campaign manager 204 can determine whether to use a given marketing campaign in connection with the marketing medium 110a at the client device 108a. For example, the campaign manager 204 can select from a plurality of available marketing campaigns based on various criteria associated with selecting marketing campaigns, such as how often a particular campaign can be selected. In one or more embodiments, the campaign manager 204 can select the marketing campaign in response to a request from the client device 108a to deliver an advertisement or other marketing content to the client device 108a.

In one or more embodiments, the campaign manager 204 can determine whether the given marketing campaign is compatible with the marketing medium 110a at the client device 108a. Specifically, a marketing campaign may include certain types of marketing content that are available for presentation within certain applications with specific functionality. For example, a marketing campaign may include video content that is compatible only with applications at the client device 108a that are capable of displaying video content. Other applications at the client device 108a may limit the marketing content to digital images.

The asset management system 102 can also include an asset manager 206 to facilitate selection and delivery of digital design assets to deliver to the client device 108a or to other devices. The asset manager 206 can select one or more digital design assets in connection with a marketing campaign selected by the campaign manager 204. For example, the asset management system 102 can access the asset repository 210 to identify digital design assets that correspond to a selected marketing campaign and deliver the identified digital design assets to the client device 108a via the marketing medium 110a. To illustrate, the asset manager 206 can select an advertisement or other marketing content approved for use with the selected marketing campaign to deliver to the client device 108a for displaying on a specific website in a web browser on the client device 108a.

The asset management system 102 can include an analytics manager 208 to facilitate management of analytics received from the analytics server 106. Specifically, the analytics manager 208 can include, but is not limited to, an analytics data manger and a score calculator. The analytics data aggregator 212 can receive and aggregate analytics data from the analytics server 106. For example, the analytics data aggregator 212 can receive campaign tracking data and asset tracking data from the analytics server 106 that the analytics server 106 collected from the client device 108a in connection with one or more marketing campaigns. The analytics data aggregator 212 can aggregate the received analytics data to store with the digital design assets in the asset repository 210, as described below.

The analytics manager 208 can also include a score calculator 214 to facilitate calculating an analytics score that can aid in improving marketing campaigns and digital design assets. In particular, the score calculator 214 can use the aggregated analytics data to determine how well a digital design asset and/or a campaign is performing based on the usage and performance data aggregated by the analytics manager 208. For example, the score calculator 214 can determine the analytics score based on the number and types of interactions with the marketing campaigns and/or digital design assets.

The asset repository 210 can store and manage digital design assets 216 for use in a plurality of marketing campaigns or otherwise. Specifically, the asset repository 210 can include various types of digital design assets 216 for use in different marketing campaigns via various marketing media. For example, the digital design assets 216 can include, but are not limited to, digital images 218, video files 220, audio files 222, and/or any combination thereof. The asset repository 210 may include digital design assets 216 generated by content creators associated with an advertiser, commercial entity, or content provider that provides marketing content to users. To illustrate, when a content creator generates a new digital design asset, the content creator can store the digital design asset in the asset repository 210 so that the digital design asset becomes available for use in marketing campaigns or to other designers, marketers, web managers or other users associated with the content creator (e.g., others in the company for which the content creator works). In additional, or alternative, embodiments, the asset repository 210 can include digital design assets 216 obtained from third party sources.

In one or more embodiments, the asset repository 210 can also include the asset identifiers for the digital design assets 216. Specifically, the asset identifiers are unique identifiers that allow the analytics server 106 to identify the digital design assets 216 used in marketing campaigns, and for the analytics manager 208 to identify the appropriate digital design assets 216 when aggregating analytics data and storing the aggregated analytics data with the digital design assets 216. In one or more embodiments, the asset identifiers are embedded in the digital design assets 216 (e.g., at the time of creation of the assets 216) and stored in the asset repository 210 with the digital design assets 216. In additional, or alternative embodiments, the asset repository 210 can store the asset identifiers in a table or database that links the asset identifiers to their respective digital design assets 216. Additionally, the server device(s) 104 can store and manage the campaign identifiers for the marketing campaigns.

The asset repository 210 can also manage and store aggregated analytics 224 from the analytics manager 208. Specifically, the asset repository 210 can manage and store the aggregated analytics 224 for a given digital design asset with the given digital design asset. For example, the aggregated analytics 224 stored with the given digital design asset can include the usage data 226 and performance data 228 collected for the digital design asset by the analytics server 106 and aggregated at the analytics manager 208. To illustrate, the aggregated analytics 224 for a given digital design asset can include how many times the digital design asset has been used with a plurality of marketing campaigns and with which campaigns the digital design asset has been used. Additionally, the aggregated analytics 224 for the given digital design asset can include the number and types of user interactions and data associated with the user interactions for the given digital design asset.

The aggregated analytics 224 can additionally include the analytics score 230 calculated for the given digital design asset. Specifically, providing the analytics score 230 with the digital design asset can allow a content creator and/or advertiser or other entity to view how well the digital design asset is performing in a single value. For example, the analytics score 230 can provide an objective metric for measuring against other digital design assets or against a scale of values to determine whether the digital design asset is performing well. The analytics score 230 also allows for improving marketing campaigns by determining which digital design assets are performing best or how well a content creator is performing based on an average analytics score 230 of the creator's digital design assets. To illustrate, advertisers or other entities can select digital design assets that perform better in other campaigns for new or existing campaigns to possibly improve the performance of the marketing campaigns.

In one or more embodiments, the analytics score 230 can also provide insight into creating new digital design assets. In particular, the analytics score 230 can allow content creators to generate new digital design assets that are similar to digital design assets that have performed or are performing well. For example, the content creators can generate new digital design assets that are more likely to perform well by identifying and incorporating one or more characteristics of digital design assets with high analytics score 230s into the new digital design assets. In at least some implementations, the asset management system 102 can automatically determine the characteristics of digital design assets with high analytics score 230s for incorporating into new digital design assets or for modifying existing digital design assets.

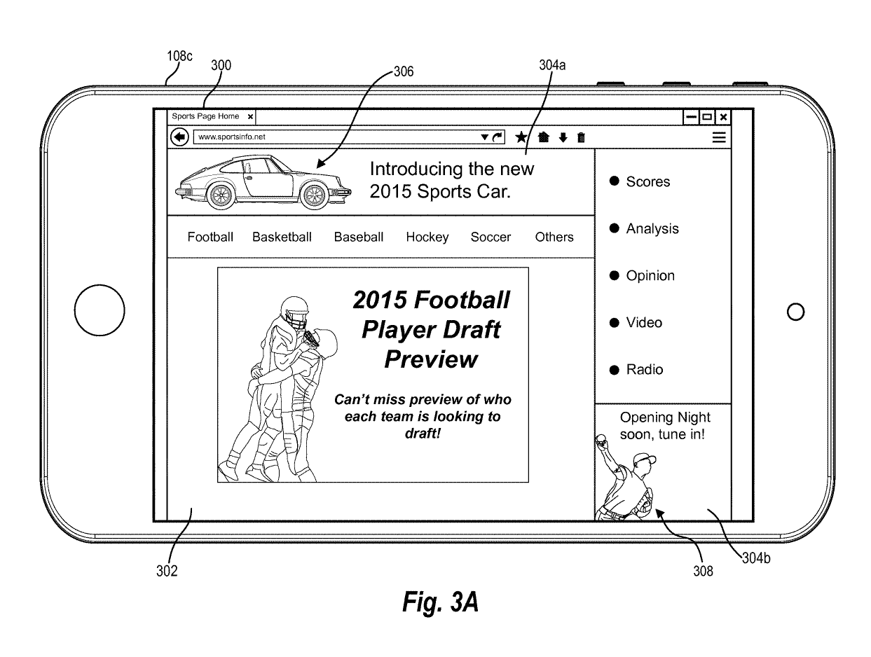

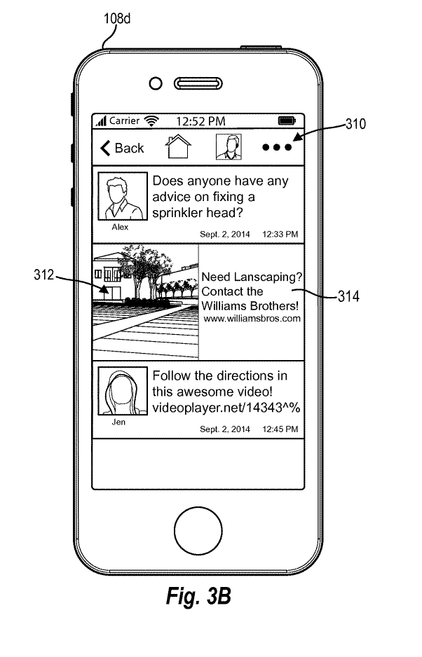

As described previously, the asset management system 102 can provide marketing content for a plurality of marketing campaigns via various marketing media. FIGS. 3A-3B illustrate user interfaces for displaying marketing campaigns on a plurality of client devices. Specifically, each marketing campaign can include one or more digital design assets delivered to one or more client devices via one or more marketing media. For example, FIG. 3A illustrates a web browser 300 that may be displayed on a client device 108c, such as a desktop computer or a tablet.

In one or more embodiments, the client device 108c can display content associated with a website 302 to which a user has navigated. For example, the client device 108c can display content that is part of the website 302, as well as one or more advertisements displayed in one or more designated areas of the website 302. To illustrate, the web browser 300 of FIG. 3A illustrates a website 302 that contains content about sports and a first area 304a and a second area 304b designated for advertisements or other marketing content associated with one or more marketing campaigns. Although FIG. 3A illustrates a website 302 with specific content and a specific number of areas designated for marketing content, the website 302 may contain any type and amount of content, as well as other numbers or types of areas for marketing content. For example, the website 302 may include a video interface for streaming video content, as well as for providing video marketing content within the same video interface.

In one or more embodiments, when the user attempts to access the website content, the client device 108c can communicate with a web server or other content provider to obtain the website content to display within the web browser 300 of the client device 108c. The web server can provide the content of the website 302 to the client device 108c via a network connection. When the client device 108c receives the content from the web server, the client device 108c can render the content according to a layout determined by the web server or by a website owner.

Additionally, in one or more embodiments, the client device 108c can determine that the website 302 contains areas for marketing content. In response to a determination that the website 302 contains areas for marketing content, the client device 108c (or the web server) can communicate with the asset management system 102 to obtain marketing content associated with one or more marketing campaigns selected by the asset management system 102. The asset management can then provide one or more digital design assets associated with the selected marketing campaign(s) for presentation within the website 302 at the areas designated for marketing content. In at least some implementations, the marketing content can include a banner ad (e.g., the first area 304a), an ad in a navigation bar of the website 302 (e.g., the second area 304b), or even as part of the website content (e.g., a background image or digital design assets that the content creator generated for use with a website 302 of the content provider or advertiser).

To illustrate, FIG. 3A includes a first digital design asset 306 as part of the banner ad on the website 302, and a second digital design asset 308 as part of the navigation bar ad on the website 302. The illustrated digital design assets 306, 308 are part of separate marketing campaigns, though the digital design assets 306, 308 may be part of the same marketing campaign. Additionally, the first digital design asset 306 and the second digital design asset 308 each include a unique asset identifier that allows the asset management system 102 to distinguish the first digital design asset 306 and the second digital design asset 308 from each other, as well as from other digital design assets that may be used in the website 302.

As described previously, the asset management system 102 can identify analytics associated with marketing content/campaigns used in connection with a marketing medium (e.g., the website 302) at the client device 108c. For example, the asset management system 102 can communicate with the client device 108c in a first request (e.g., at the time of loading a webpage) to identify a campaign identifier associated with the campaign to be used with the webpage. To illustrate, the asset management system 102 can select a marketing content with the corresponding campaign identifier to be used in a website 302. Upon identifying the campaign identifier, the asset management system 102 can provide one or more pieces of marketing content that includes digital design assets to the client device 108c for display in the appropriate areas of the website 302.

Although the present disclosure describes the communications between client devices and the asset management system 102 as a request to identify specific identifiers, the communications can include operations performed by the client devices to send information to the asset management system 102 without an explicit request from the asset management system 102. For example, a marketing medium can include code that causes the client device 108c to communicate information to the asset management system 102 in response to loading and displaying content in the marketing medium. To illustrate, a webpage can include code (e.g., JavaScript) that causes the client device 108c to send information to the asset management system 102 without receiving an explicit request from the asset management system 102 for the information.

In one or more embodiments, the asset management system 102 can collect analytics associated with the marketing campaign simultaneously or substantially simultaneously at the time of using the marketing campaign at the client device 108c. Specifically, the asset management system 102 can perform a request to verify that the marketing content has been used at the client device 108c, and identify the campaign identifier for the marketing content. For example, the asset management can perform a first request to identify the campaign identifier and collect analytics data that describes that an advertisement in the marketing campaign was displayed at the client device 108c. Additionally, the asset management system 102 can identify the marketing medium used to deliver the advertisement (e.g., website content, as in FIG. 3A).

According to one or more additional, or alternative, embodiments, the asset management system 102 can collect analytics associated with the digital design assets used in connection with the marketing content in a subsequent request to the client device 108c. In particular, the asset management system 102 can perform a second request after identifying the campaign identifier to determine that the asset management system 102 delivered one or more digital design assets to the client device 108c to be included in an advertisement of the marketing campaign. For example, the asset management system 102 can perform a second request separate from the first request to identify one or more asset identifiers of assets provided to, and displayed in, the website 302, such as when the client device 108c loads and displays the digital design asset. Thus, the asset management system 102 can identify the one or more digital design assets separately from the marketing campaign. Alternatively, the asset management system 102 can identify the campaign identifier and the asset identifier(s) in the same request. More particularly, a web page including digital design assets can include a JavaScript tag that identifies which digital design assets were loaded on the web page. The JavaScript tag can identify which digital design assets are associated with the asset management system 102 and send back a list of the asset IDs to the asset management system 102.

Additionally, the asset management system 102 can identify the marketing medium in connection with the delivered marketing content. Specifically, the asset management system 102 can identify a source identifier that corresponds to the specific marketing medium by which the asset management system 102 has delivered a digital design asset to the client device 108c. For example, the asset management system 102 can identify a source identifier that describes that the marketing medium is a type of medium and/or the specific medium itself. To illustrate, the asset management system 102 can detect a source identifier from the client device 108c to identify that the marketing medium is a website and/or that the website is a specific website. Thus, the asset management system 102 can determine with which marketing campaigns and marketing media an asset has been used, and where the digital design asset has been used.

In one or more embodiments, the asset management system 102 can identify more than one digital design asset displayed in the same marketing medium at the client device 108c. For example, as illustrated in FIG. 3A, the asset management system 102 can determine that the website 302 contains a first digital design asset displayed as a banner ad, and a second, smaller asset displayed in a navigation bar of the website 302. The asset management system 102 can identify each digital design asset based on the corresponding asset identifiers that the asset management system 102 can request from the client device 108c. For example, the asset management system 102 can request any asset identifiers in the webpage in the second request to the client device 108c.

Additionally, or alternatively, the asset management system 102 can determine to which marketing campaigns each digital design asset belongs based on the identified campaign identifier(s). Specifically, the asset management system 102 can also identify a plurality of campaign identifiers in the first request to the client device 108c prior to obtaining the asset identifiers. When requesting the asset identifiers from the client device 108c, the asset management system 102 can determine that the first digital design asset corresponds to a first marketing campaign, and the second digital design asset corresponds to a second marketing campaign based on the campaign identifiers and the corresponding asset identifiers. Alternatively, the asset management system 102 can determine that the one or more digital design assets are part of the same marketing campaign based on the corresponding campaign identifiers and asset identifiers.

As mentioned, identifying the marketing campaigns and corresponding digital design assets to be used in connection with the marketing medium to provide marketing content to the client device 108c can allow the asset management system 102 to collect analytics data for the marketing campaigns and digital design assets. For example, the asset management system 102 can collect usage data for the marketing campaigns and the assets to determine how many times the marketing campaigns and assets have been used. In particular, the asset management system 102 can track the number of impressions (e.g., if the advertisement is fetched and/or displayed) associated with each marketing campaign/asset. To illustrate, after fetching a digital design asset and displaying the digital design asset on the website 302, the asset management system 102 can count the instance of the asset provided to the client device 108c as an impression. The usage data can also include information that identifies the names and numbers of the marketing campaigns that include the asset.

Additionally, one or more embodiments of the asset management system 102 can collect performance data for the marketing campaigns and the assets to determine numbers and types of interactions with the marketing campaigns and the assets. Specifically, the asset management system 102 can determine whether one or more users interact with a marketing campaign or a digital design asset at the client device 108c via the marketing medium. For example, the performance data can include a data associated with user clicks, unique users to view the marketing campaigns/assets, conversions of users to customers, as well as targeting segments (e.g., user demographic information). In one or more embodiments, the asset management system 102 can assign each segment a unique segment identifier and including the segment identifier with the campaigns and/or digital design assets to allow for individual tracking of the segments.

In one or more embodiments, when a user interacts with a digital design asset, the client device 108c can perform an operation to redirect the user to another webpage or website. For example, if the user clicks on a digital design asset displayed in the web browser 300 at the client device 108c, the digital design asset can cause the client device 108c of the user to redirect the web browser 300 to a website corresponding to the marketing campaign that includes the asset. To illustrate, clicking on an advertisement (e.g., the car advertisement) can cause the client device 108c of the user to redirect the web browser 300 to a website of the advertiser (e.g., a webpage containing information about the car).

Additionally, the asset management system 102 can collect performance data in connection with a user interaction with the asset and/or marketing campaign. In particular, when the user interacts with a digital design asset, the asset management system 102 can detect the asset identifier for the digital design asset in a request from the client device 108c to the server device(s) 104, or to another device, to fetch the webpage corresponding to the marketing campaign. Similarly, the asset management system 102 can also detect the campaign identifier for the marketing campaign that corresponds to the selected digital design asset. Alternatively, the asset management system 102 can identify the marketing campaign and the digital design asset in separate requests or communications with the client device 108c associated with the user interaction. The asset management system 102 can then increment a value corresponding to the number of clicks on the asset and/or the marketing campaign at the asset repository 210.

In one or more embodiments, if the user interaction with the digital design asset results in a conversion, the asset management system 102 can store the corresponding analytics data with the asset at the asset repository 210. Specifically, the asset management system 102 can also track the user by way of a device identifier or a user identifier. If the user purchases goods or services as a result of the interaction with the digital design asset, the asset management system 102 can determine that the purchase corresponded to the interaction based on the device identifier or user identifier associated with the user interaction.

When tracking usage and performance of marketing campaigns and digital design assets, the asset management system 102 can use any suitable method for identifying the campaign identifiers and asset identifiers in the various marketing media. For example, when tracking campaigns and assets in a webpage, the asset management system 102 can identify a campaign identifier and an asset identifier using JavaScript protocols. To illustrate, the asset management system 102 can identify the campaign identifier and the asset identifier using page tagging methods to detect JavaScript code or tags embedded in the webpage corresponding to the campaign identifier and the asset identifier.

Additionally, or alternatively, the asset management system 102 can use other methods of detecting the identifiers, such as log processing. Specifically, a content delivery network or an edge network that serves content to client devices may include log files that store a record of file requests by the client devices. By analyzing the log files, the asset management system 102 may be able to determine which digital design assets were provided to the client device in a particular webpage. The asset management system 102 many use some combination of page tagging or log processing to identify usage and performance of the marketing campaigns and digital design assets.

FIG. 3B illustrates another user interface at a client device 108d that is capable of displaying digital design assets to a user. Specifically, FIG. 3B illustrates a mobile device displaying a user interface for a social application 310. For example, the social application can be a standalone application, or an application that interfaces with one or more different social media services, allowing the user to interact with others via the application, rather than through a web browser 300. To illustrate, the social application 310 can include a message board that allows users to communicate with other users of the social application 310 to discuss various topics (e.g., gardening or home improvement, as shown in FIG. 3B) or to ask questions of other users.

In one or more embodiments, the asset management system 102 can provide digital design assets and other marketing content to the mobile device of the user within the social application 310. Specifically, the asset management system 102 can determine that the social application 310 is a different marketing medium than a web browser 300 and provide marketing campaigns and digital design assets that are compatible with the marketing medium of the social application 310. For example, the asset management system 102 can select digital design assets that are designed specifically for use in mobile applications. The asset management system 102 can provide the digital design assets to the social application 310 so that the user can view the digital design asset while viewing the content of the application. To illustrate, asset management system 102 can serve a digital design asset 312 to the client device 108d for displaying in a designated advertisement area 314 of the social application 310.

Additionally, the asset management system 102 can provide digital design assets in accordance with one or more targeted advertising campaigns. In particular, the asset management system 102 can identify an opportunity for a targeted advertisement based on content displayed in association with one or more marketing media at each client device. For example, the asset management system 102 can determine that a website 302 includes sports and entertainment content and can select marketing campaigns that may be relevant to users who view sports and entertainment content. To illustrate, the asset management system 102 can select a marketing campaign directed to sports cars, and can select a corresponding digital design asset depicting a particular sports car, as illustrated in FIG. 3A. The asset management system 102 can also select an additional marketing campaign directed to advertising an upcoming baseball game or season, and can thus select an asset accordingly.

In one or more embodiments, the asset management system 102 can deliver content associated with a plurality of marketing campaigns to a client device via a single marketing medium. For example, the asset management system 102 can select the two different marketing campaigns depicted in FIG. 3A. Each marketing campaign may have different digital design assets, each with unique asset identifiers that allow the asset management system 102 to identify the assets and track usage and interactions of the assets separately from each other and from the respective marketing campaigns.

Additionally, or alternatively, the asset management system 102 can select a single marketing campaign and provide a plurality of digital design assets associated with the marketing campaign. For example, the asset management system 102 can select the digital design assets by identifying asset identifiers that correspond to a single marketing campaign to provide to one or more client devices. To illustrate, the asset management system 102 can select a plurality of digital design assets that correspond to the sports car marketing campaign described previously, and provide a plurality of corresponding assets to the client device to display within the marketing medium at the same time (e.g., multiple different ads for the sports car).

In one or more embodiments, to determine whether to use a digital design asset in a marketing campaign, the asset management system 102 can verify that the digital design asset corresponds to a marketing campaign based on a database that contains the corresponding asset identifiers. For example, the asset management system 102 can determine that a digital design asset corresponds to a campaign by identifying whether the asset identifier of the digital design asset is mapped to a campaign identifier of the campaign. To illustrate, the database may include a set of mappings for each asset identifier with one or more campaign identifiers. In one or more implementations, an asset identifier can be mapped to a plurality of campaign identifiers, such that the corresponding digital design asset can be used in a plurality of marketing campaigns. Additionally, or alternatively, a digital design asset may be mapped to only one campaign identifier.

Although FIGS. 3A and 3B illustrate embodiments of digital design assets in certain marketing media and on certain devices, the asset management system 102 can manage and provide marketing content to a variety of client devices and a variety of marketing media. Specifically, the asset management system 102 can typically provide a digital design asset in conjunction with a marketing campaign to many different client devices at different times and via various marketing media. For example, the asset management system 102 can provide a digital design asset used in a marketing campaign to a plurality of different types of client devices when the users of the respective client devices access marketing media that are compatible with the marketing campaign. To illustrate, the asset management system 102 can deliver the digital design assets in response to requests from each of the client devices to retrieve or view the same or similar digital design assets in association with one or more marketing campaigns by way of different marketing media—for example, a website, a social application, an email marketing campaign, and/or a/b testing or other targeting experiences, etc.

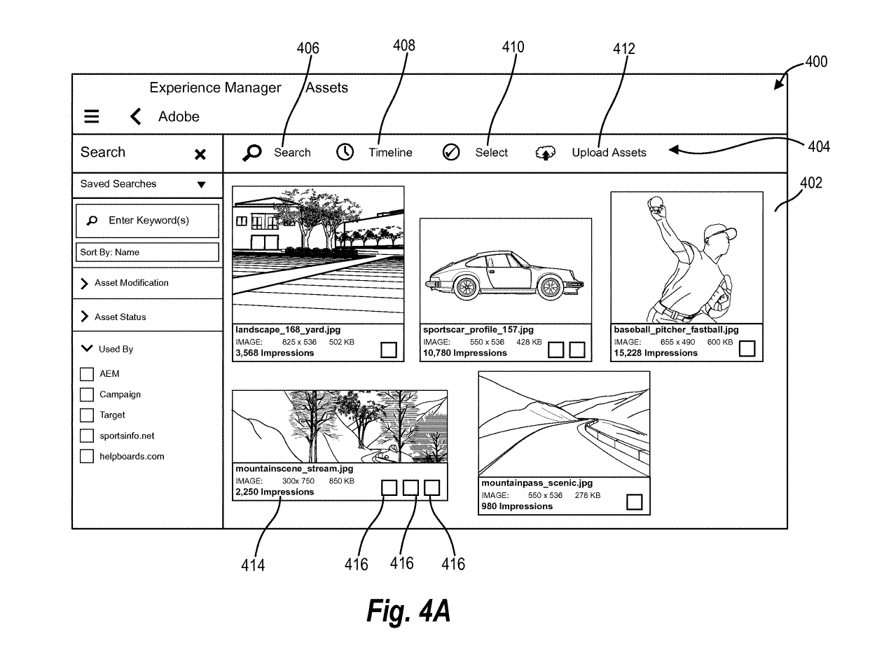

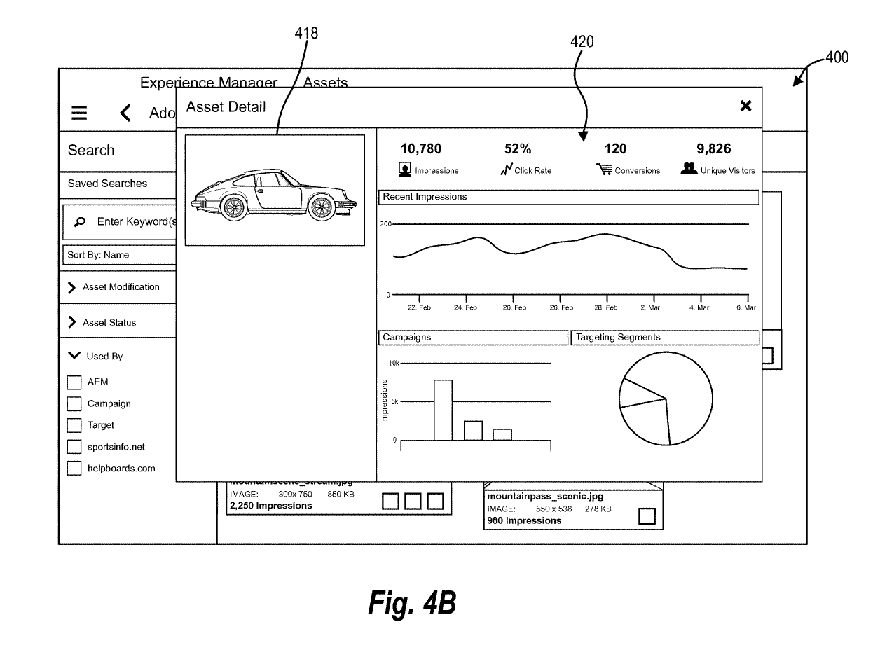

As mentioned previously, the asset management system 102 can provide analytics data with the digital design assets in the asset repository 210. FIGS. 4A-4B illustrate user interfaces for an asset management application 400 to display a plurality of digital design assets and analytics data relating to the usage and performance of the plurality of digital design assets in the asset repository 210. The provided analytics data can allow content creators, advertisers, and/or other entities to view the analytics data for the digital design assets to determine how well the digital design assets are performing and where the asset management system 102 has used the digital design assets.

FIG. 4A illustrates an example user interface for the asset management application 400. In one or more embodiments, the asset management application 400 can include an asset section 402 to display assets that have been used in marketing campaigns or that are available for use in marketing campaigns. In particular, the asset management application 400 can include a toolbar 404 for viewing and interacting with digital design assets in the asset repository 210. For example, the toolbar 404 can include, but is not limited to, a search tool 406, a timeline tool 408, a select tool 410, and an upload tool 412.

In one or more embodiments, the search tool 406 can allow the user to search for a specific digital design asset or group of digital design assets in the asset repository 210. For example, the search tool 406 can allow the user to search by keyword, name, category, status, modification, or other characteristics to allow a user to more easily find a desired digital design asset or group of digital design assets. To illustrate, using the search tool 406 can cause the asset management application 400 to display results of a search for one or more digital design assets. Additionally, the search tool 406 can allow a user to search for digital design assets used in specific marketing campaigns or in specific marketing platforms (e.g., digital design assets used at a particular website, in a particular application, or with a particular delivery method).

In one or more embodiments, the timeline tool 408 can provide information about when a digital design asset was last used and/or created. For example, selecting the timeline tool 408 can allow the user to change how the digital design assets are displayed within the asset management application 400. To illustrate, selecting to display the digital design assets based on creation date can cause the asset management application 400 to display the digital design assets in the repository in an order corresponding to the creation date of each digital design asset. Alternatively, the timeline tool 408 can cause the asset management application 400 to display assets based on when the digital design assets were last used in a marketing campaign.

According to one or more embodiments, the asset management application 400 can include a select tool 410 to select one or more digital design assets for viewing and/or using the asset. Specifically, the select tool 410 can allow a user to select a specific asset or group of assets for viewing the corresponding analytics data, as described in more detail with reference to FIG. 4B. Additionally, or alternatively, the select tool 410 can allow a user to select a specific digital design asset or group of digital design assets for deleting or modifying the asset. For example, a content creator can modify digital design assets after storing the digital design assets in the asset repository 210.

The upload tool 412 can allow a content creator or entity to upload new content to the asset repository 210. For example, when a content creator has finished generating a new digital design asset, the user can select to upload the digital design asset to the asset repository 210. Additionally, uploading a new digital design asset can cause the application management application to rearrange visible digital design assets based on display criteria for the assets repository. In one or more embodiments, uploading a new digital design asset to the asset repository 210 via the asset management application 400 can cause the asset management system 102 to assign a new asset identifier to the digital design asset, or to identify an already embedded asset identifier for the digital design asset.

In one or more embodiments, the asset management application 400 can display analytics data 414 for each of the digital design assets. Specifically, the asset management application 400 can display one or more data points from a plurality of data points that provide a brief synopsis of how well the digital design assets are performing. For example, as shown by FIG. 4A, the asset management application 400 displays analytics data 414 including, but not limited to, a name or filename of each asset, file specifications (e.g., image dimensions, file size, or audio/video length) a total number of impressions for each digital design asset across a plurality of marketing campaigns. In alternative embodiments, the asset management application 400 can display any of the analytics data collected for the digital design assets or allow a user to selectively configure which data is shown.

In one or more embodiments, the asset management application 400 can also display which marketing campaigns or marketing media have used each asset. To illustrate, the asset management application 400 can display an icon 416 representing each marketing medium that has used a particular digital design asset. For example, the icons 416 can indicate that a particular digital design asset was used in social application, on a web page, in an email campaign, or other marketing medium or type of campaign. Thus, the icons 416 can comprise an icon for each of a plurality of different uses for digital design assets. Each time a digital design asset is used in a particular manner, the asset management system 102 can add and display the associated icon 416 with the digital design asset.

One will appreciate that the asset management application 400 can allow users/marketers to browse and select digital design assets. More particularly, the asset management application 400 can aggregate all of the digital design assets of an organization and the track and provide analytics data for each of the digital design assets. Furthermore, the asset management application 400 can allow users to filter the digital design assets based on the tracked analytic data. For example, the asset management application 400 can allow a user to filter digital design assets based on the marketing campaigns or marketing media in which they have been used, the impressions, click-thru-rates, likes, revenue, conversions, shares, or any other of the tracked data for the digital design assets. One will appreciate that for organizations that have large numbers of digital design assets, the ability to sort and find effective digital design assets based on prior use and effectiveness is a powerful tool.

As an example, the asset management application 400 allows users to sort digital design assets by click rate in order to see which sort digital design assets are providing the best click rates at a given time. Furthermore, the asset management application 400 can allow a marketer to find a digital design asset that has been performing well for a certain area. For example, the asset management application 400 can allow the marketer to find digital design assets that have been performing well for males within the ages of 25 and 30. Thus, the asset management application 400 allow user not only to find out which digital design assets are performing, but then to be able to find digital design assets that will likely be successful in a given marketing campaign or for a given targeted segment of users.

In one or more embodiments, the asset management system 102 can allow a user to view additional, or more granular, analytics data for a given digital design asset. For example, FIG. 4B illustrates a user interface of the asset management application 400 of FIG. 4A while providing additional analytics data about a selected digital design asset 418 in the asset repository 210. To illustrate, selecting a particular digital design asset 418 can cause the asset management application 400 to display a detailed report 420 about the usage and performance of the selected digital design asset 418.

As mentioned, the asset management application 400 can provide usage and performance data for a digital design asset. A detailed report can include usage data, performance data, and at least some analytics pertaining to demographics of users who have seen and/or interacted with the selected digital design asset. Specifically, the detailed report can include, but is not limited to, number of impressions, click rate, conversions, unique visitors that have viewed the digital design asset, campaigns that have used the digital design asset, trends in usage/performance, comments associated with the digital design asset, and targeting segments related to user demographics (e.g., age, gender, socioeconomic status, education). A detailed analytics report 420 can provide an improved understanding of the usage and performance of a digital design asset.

The asset detail shown in FIG. 4B includes a copy of the digital design asset 418 and associated analytics data for the digital design asset 418. In particular, the asset detail includes the number of impressions, the click through rate, conversions, unique visitors, a graph of recent impressions, a listing of different campaigns in which the digital design asset 418 has been used, and a list of different segments to which the digital design asset 418 has been targeted.

By providing detailed analytics data about a digital design asset to a content creator or advertiser, the asset management system 102 can aid in creating new assets for use in improving existing marketing campaigns or generating new marketing campaigns. In one or more embodiments, the asset management system 102 can identify characteristics of a successful digital design asset. Specifically, the asset management system 102 can determine that a digital design asset has a successful conversion rate, impression rate, etc., and can then identify one or more characteristics of the digital design asset that may have caused the asset to be successful. Alternatively, the asset management system 102 can identify common characteristics of a plurality of successful digital design assets to determine which characteristics are most likely to contribute to successful digital design assets. The asset management system 102 can include these characteristics in the asset management application 400 and/or with the digital design assets in the asset repository 210 for quick and easy identification by the content creator or advertiser.

After the asset management system 102 identifies one or more characteristics of a successful digital design asset, a content creator can incorporate the identified characteristics into a new digital design asset to improve the likelihood of the new digital design asset performing well. Similarly, the content creator may be able to modify existing digital design assets with the identified characteristics to improve the likelihood that the existing digital design assets are successful. Additionally, the asset management system 102 can use the identified characteristics to improve the success of marketing campaigns by selecting digital design assets that include the successful characteristics or are successful as deemed by the analytics data (e.g., by an analytics score). By continuously monitoring characteristics of successful digital design assets, the asset management system 102 can identify when certain characteristics become more indicative of success than others.

In one or more embodiments, the asset management system 102 may automatically create new digital design assets based on previous digital design assets. Specifically, the asset management system 102 can provide an interface that allows a user to select digital design assets that have performed well previously and automatically create new digital design assets that are similar to the successful digital design assets. For example, the asset management system 102 can use machine learning to identify the characteristics of the successful digital design assets and generate new content that contains the identified characteristics without additional user input.

The asset management system 102 can also help marketers discover which assets are appealing to different segments or demographic of users. For example, the asset management system 102 can identify one or more attributes of a user based on information associated with websites or applications visited/used by the user, digital design assets with which the user interacts, or other analytics associated with the user's browsing or application usage habits. To illustrate, the asset management system 102 can identify a user's approximate age, as well as the user's interests. Additionally, or alternatively, the asset management system 102 can identify information about the user based on a user profile with the asset management system 102 or a service related to the asset management system 102. The asset management system 102 can provide the demographic data associated with the user with digital design assets with which the user has interacted at the asset repository 210. Thus, the asset management system 102 can provide targeting segment information to the asset creator and/or advertiser in connection with assets at the asset repository 210 to aid in improving marketing campaigns to targeted segments.

In one or more embodiments, the asset management system 102 can collect also analytics for digital design assets that are not part of the asset repository 210. Specifically, a marketing medium may include content that is not managed by the asset management system 102. When the client device sends analytics data to the asset management system 102, the asset management system 102 can identify all digital design assets included in the content at the client device, including assets not managed by the asset management system 102. To illustrate, the asset management system 102 can assign identifiers to digital design assets not managed by the asset management system 102 based on a customer account identifier, filename or contents of the assets, or some combination thereof, and store the analytics data with the assigned identifiers. If a user later adds the digital design assets to the asset repository 210, the asset management system 102 can link the collected analytics data to the digital design asset.

In additional embodiments, the asset management system 102 can include an analytics score for the digital design asset in the detailed report 420. Specifically, the asset management system 102 can calculate the score for the digital design asset based on the other analytics data collected for the digital design asset and provide the analytics score with the digital design asset. As mentioned previously, the analytics score can provide a quick, objective measure of how the asset performs on a performance scale, or relative to other assets. The asset management system 102 can also use the analytics scores for a plurality of digital design assets to determine how well a particular campaign, marketing medium, or content creator is performing.

In one or more embodiments, the asset management system 102 can calculate an analytics score S as:

S=A_{S}(C₁)+Aₛ(C₂)+ . . . A_{S}(Cₙ),

where A is the digital design asset, A_{S} is the digital design asset's score for a particular campaign, and C₁, C₂, . . . Cₙ, are a plurality of campaigns across a plurality of marketing media. For example, the score for a particular campaign can be:

A_{S}(C₁)=w₁i₁+w₂i₂+wₙiₙ,

where i₁, i₂, . . . iₙ are interactions with the asset, characteristics of the asset, or other analytics data associated with the asset, and w₁, w₂, . . . wₙ are configurable weights applied to each interaction based on campaign goals. To illustrate, a social campaign can use interactions such as comments, likes, and shares to determine the score for the digital design asset. Alternatively, a web campaign can use the number of impressions, clicks, or other key performance indicators that can indicate a successful asset performance.

The analytics data associated with a digital design asset can provide valuable insights for both marketers and content creators. For example, the analytics data can provide a marketer with information about how often a digital design asset is used in multiple marketing media; popular and trending assets; positive/negative feedback associated with the digital design asset; recommendations/predictions for using similar digital design assets in marketing campaigns based on performance; performance of content creators (i.e., individuals or entities); and/or effective return on digital design asset based on impact generated. Additionally, the analytics data can provide content creators with information about how well the content creator is performing based on the performance of the creator's digital design assets and measurement against campaign goals; inspiration for creating new content based on popular/trending digital design assets, themes or patterns; recommendations on providing new patterns, colors, or other characteristics of the digital design assets.

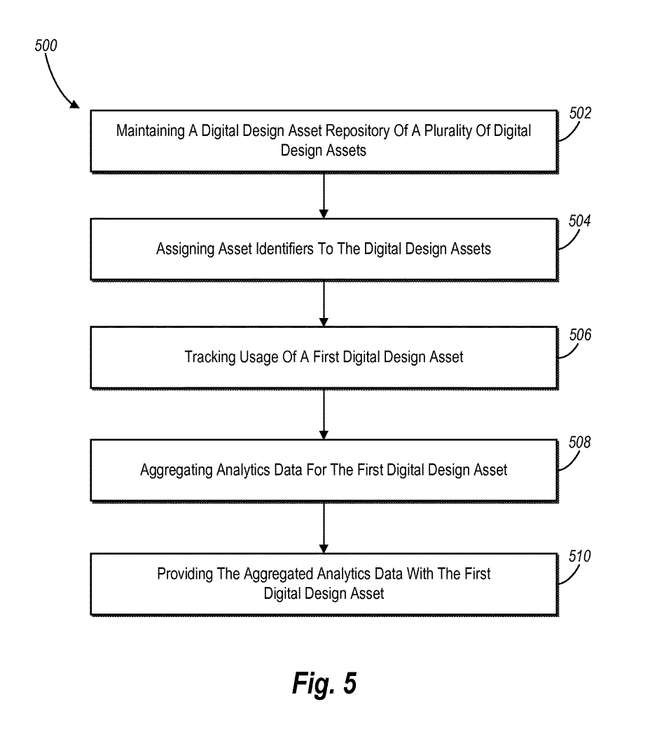

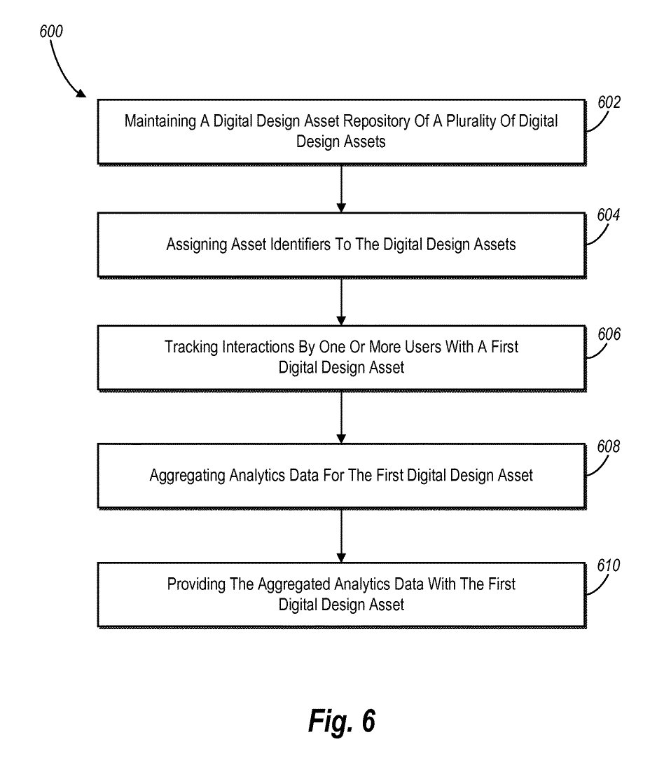

FIGS. 1-4B, the corresponding text, and the examples, provide a number of different systems and devices for authenticating user access to content based on an augmented token. In addition to the foregoing, embodiments can be described in terms of flowcharts comprising acts and steps in a method for accomplishing a particular result. For example, FIGS. 5 and 6 illustrate flowcharts of exemplary methods in accordance with one or more embodiments.

FIG. 5 illustrates a flowchart of a method 500 of analyzing usage of digital design assets for asset selection. The method 500 includes an act 502 of maintaining a digital design asset repository 210 of a plurality of digital design assets. For example, act 502 involves maintaining a digital design asset repository 210 of a plurality of digital design assets available for use in marketing campaigns, the digital design assets comprising digital images, video files, or audio files.

The method 500 also includes an act 504 of assigning asset identifiers to the digital design assets. For example, act 504 involves assigning asset identifiers to the digital design assets in the digital design asset repository 210. To illustrate, act 504 can involve assigning a digital fingerprint to the digital design assets when the digital design assets are generated. Alternatively, act 504 can involve generating an asset identifier based on at least one of content creator account information, a filename, or content of a digital design asset.

Additionally, the method 500 includes an act 506 of tracking usage of a first digital design asset 306. For example, act 506 involves tracking usage of a first digital design asset 306 in a plurality of marketing campaigns. To illustrate, act 506 can involve assigning a first campaign identifier to a first marketing content comprising the first digital design asset 306. Act 506 can also involve assigning a first asset identifier to the first marketing content comprising the first digital design asset. Additionally, act 506 can involve tracking usage of the first marketing content based on the first campaign identifier and tracking usage of the first digital design asset in the first marketing content based on the first asset identifier. To illustrate, act 506 can involve identifying the first campaign identifier and the first digital design asset identifier in JavaScript commands in connection with the marketing medium.

As part of act 506, or as an additional act, the method 500 can further include assigning a second campaign identifier to a second marketing content comprising the first digital design asset. The method 500 can then involve assigning the first asset identifier to the second marketing content comprising the first digital design asset. The method 500 can involve tracking usage of the second marketing content based on the second campaign identifier and tracking usage of the first marketing content based on the first campaign identifier. In such cases, aggregating analytics data for the first digital design asset comprises aggregating analytics data for the first digital design asset in connection with the first marketing campaign and analytics data for the first digital design asset in connection with the second marketing campaign.

As part of act 506, or as an additional act, the method can include an act of tracking usage of a second digital design asset in the first marketing content by assigning a second digital design asset identifier to the first marketing content. The method can further include an act of associating the first campaign identifier with the first asset identifier and augmenting the tracking data for the first digital design asset upon each detected use of the first campaign identifier.

The method 500 further includes an act 508 of aggregating analytics data for the first digital design asset 306. For example, act 508 can involve aggregating analytics data for the first digital design asset 306 based on the tracked usage of the first digital design asset 306. To illustrate, the aggregated analytics data can comprise a number of times that the digital design asset has been used in a marketing campaign from the plurality of marketing campaigns. Additionally, the aggregated analytics data can comprise performance data for the first digital design asset 306.

Additionally, act 508 can involve aggregating analytics data for the first digital design asset 306 for a plurality of marketing campaigns. Specifically, act 508 can involve combining analytics data for the first digital asset across a plurality of marketing campaigns and via a plurality of marketing media. For example, act 508 can involve aggregating analytics data for the first digital design asset 306 in connection with the first marketing campaign at the first marketing medium and the second marketing campaign at the second marketing medium.

The method 500 can also includes an act 510 of providing the aggregated analytics data with the first digital design asset 306. For example, act 510 involves providing the aggregated analytics data with the first digital design asset 306 in the digital design asset repository 210. To illustrate, act 510 can involve providing the aggregated analytics data in the digital design asset repository 210 for viewing with the first digital design asset 306 in an asset management application 400.

As part of act 510, or as an additional act, the method 500 can include an act of providing suggestions for generating new digital design assets or modifying existing digital design assets for use in the plurality of marketing campaigns. The method 500 can also include an act of selecting existing digital design assets for use in the plurality of marketing campaigns based on the aggregated analytics data of the first digital design asset 306.

FIG. 6 illustrates a flowchart of another method 600 of controlling access to content. The method 600 includes an act 602 of maintaining a digital design asset repository 210 of a plurality of digital design assets. For example, act 602 involves maintaining a digital design asset repository 210 of a plurality of digital design assets available for use in marketing campaigns, the digital design assets comprising digital images, video files, or audio files.

The method 600 also includes an act 604 of assigning asset identifiers to the digital design assets. For act 604 involves assigning asset identifiers to the digital design assets in the digital design asset repository 210. To illustrate, act 604 can involve assigning a digital fingerprint to the digital design assets when the digital design assets are generated. Alternatively, act 604 can involve generating an asset identifier based on at least one of content creator account information, a filename, or content of a digital design asset.

Additionally, the method 600 includes an act 606 of tracking interactions by one or more users with a first digital design asset 306. For example, act 606 involves tracking interactions by one or more users with a first digital design asset 306 used in a plurality of marketing campaigns. To illustrate, act 606 can involve assigning a first campaign identifier to a first marketing content comprising the first digital design asset 306. Act 606 can also involve tracking interactions with the first marketing content at a first marketing medium by identifying the first campaign identifier in connection with one or more user interactions with the first marketing content at the first marketing medium. Act 606 can further involve tracking interactions with the first digital design asset 306 in the first marketing content at the first marketing medium by identifying a first digital design asset identifier assigned to the first digital design asset 306 in connection with the one or more user interactions with the first digital design asset 306 at the first marketing medium. For example, act 606 can involve identifying the first campaign identifier and the first digital design asset identifier in separate JavaScript commands in connection with the marketing medium.

Act 606 can also involve assigning a second campaign identifier to a second marketing content comprising the first digital design asset 306, and tracking interactions with the second marketing content at a second marketing medium by identifying the second campaign identifier in connection with one or more user interactions with the second marketing content at the second marketing medium. Act 606 can also involve tracking interactions with the first digital design asset 306 in the second marketing content at the second marketing medium by identifying the first digital design asset identifier assigned to the first digital design asset 306 in connection with the one or more user interactions with the first digital design asset 306 at the second marketing medium.

Act 606 can further involve tracking interactions with a second digital design asset 308 in the first marketing campaign at the first marketing medium by identifying a second digital design asset identifier assigned to the second digital design asset 308 in connection with one or more user interactions with the second digital design asset 308 at the first marketing medium.

The method 600 further includes an act 608 of aggregating analytics data for the first digital design asset 306. For example, act 608 involves aggregating analytics data for the first digital design asset 306 based on the tracked interactions with the first digital design asset 306. To illustrate, aggregated analytics data can include a number of times that the one or more users have clicked on the first digital design asset 306, a number of advertisement conversions resulting from the tracked interactions with the first digital design asset 306, or a number of unique users that have interacted with the first digital design asset 306.

Act 608 can involve aggregating analytics data for the first digital design asset 306 for a plurality of marketing campaigns. Specifically, act 508 can involve combining analytics data for the first digital asset across a plurality of marketing campaigns and via a plurality of marketing media. To illustrate, act 608 can involve aggregating analytics data for the first digital design asset 306 in connection with the first marketing content at the first marketing medium and the second marketing content at the second marketing medium. For example, act 608 can involve a number of likes of a social advertisement including the first digital design asset; a number of shares of the social advertisement including the first digital design asset; a number of clicks on an email advertisement including the first digital design asset; or a number of impressions of a web page including the first digital design asset.

Additionally, the method 600 can include an act 610 of providing the aggregated analytics data with the first digital design asset 306. For example, act 610 involves providing the aggregated analytics data with the first digital design asset 306 in the digital design asset repository 210. To illustrate, act 610 can involve providing the aggregated analytics data in the digital design asset repository 210 for viewing with the first digital design asset 306 in an asset management application 400. More particular, act 610 can involve providing a user interface including digital design assets of the plurality of digital design assets and including next to each digital design asset in the user interface an indication of aggregated analytics data for each digital design asset. The indication can comprise an icon for each marketing medium in which the digital design assets have been used based on the aggregated analytics data.

As part of act 610, or as an additional act, the method 600 can include an act of calculating an analytics score 230 of the first digital design asset 306 based on the aggregated analytics data. The method 600 can include an act of providing the analytics score 230 with the first digital design asset 306 in the digital design asset repository 210. Calculating the analytics score can comprise calculating a campaign score for each marketing campaign in which use of the first digital design asset was tracked, multiplying each campaign score by a weight specific to the marketing campaign; and aggregating the weighted campaign scores.

Additionally, the method can include an act of determining that the analytics score 230 of the first digital design asset 306 is above a predetermined score threshold. The method can also include an act of identifying one or more characteristics of the first digital design asset 306, and selecting a second digital design asset 308 having the one or more characteristics of the first digital design asset 306 for use in a second marketing campaign. The method can also include an act of identifying one or more characteristics of the first digital design asset 306 based on the analytics score 230, and automatically generating new content comprising the one or more characteristics. Alternatively, the method can include an act of providing a suggestion for using a digital design asset from the digital design asset repository 210 in a marketing campaign based on the analytics score 230 of the first digital design asset 306.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the asset management system 102. As shown by FIG. 7, the computing device 700 can comprise a processor 702, a memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In one or more embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 706.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, storage device 706 can comprise a non-transitory storage medium described above. The storage device 706 may include a hard disk drive (HDD), a floppy disk drive, flash memory, an optical disc, a magneto-optical disc, magnetic tape, or a Universal Serial Bus (USB) drive or a combination of two or more of these. The storage device 706 may include removable or non-removable (or fixed) media, where appropriate. The storage device 706 may be internal or external to the computing device 700. In one or more embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present disclosure is, therefore, indicated by the appended claims rather than by the foregoing description. All changes that come within the meaning and range of equivalency of the claims are to be embraced within their scope.

What is claimed is:

1. A method of analyzing usage of digital design assets for asset selection, comprising:
maintaining, by one or more servers, a digital design asset repository of a plurality of digital design assets available for use in marketing campaigns, the digital design assets comprising digital images, video files, or audio files;
assigning asset identifiers to the digital design assets in the digital design asset repository;
tracking usage of a first digital design asset in a plurality of marketing campaigns;
aggregating, by the one or more servers, analytics data for the first digital design asset based on the tracked usage of the first digital design asset; and
providing, by the one or more servers, the aggregated analytics data with the first digital design asset in the digital design asset repository.

2. The method as recited in claim 1, further comprising:
assigning a first campaign identifier to a first marketing content comprising the first digital design asset;
assigning a first asset identifier to the first marketing content comprising the first digital design asset;
tracking usage of the first marketing content based on the first campaign identifier; and
tracking usage of the first digital design asset in the first marketing content based on the first asset identifier.

3. The method as recited in claim 2, further comprising:
assigning a second campaign identifier to a second marketing content comprising the first digital design asset;
assigning the first asset identifier to the second marketing content comprising the first digital design asset;
tracking usage of the second marketing content based on the second campaign identifier; and
tracking usage of the first marketing content based on the first campaign identifier,
wherein aggregating analytics data for the first digital design asset comprises aggregating analytics data for the first digital design asset in connection with the first marketing campaign and analytics data for the first digital design asset in connection with the second marketing campaign.

4. The method as recited in claim 2, further comprising tracking usage of a second digital design asset in the first marketing content by assigning a second digital design asset identifier to the first marketing content.

5. The method as recited in claim 2, wherein tracking usage of the first digital design asset comprises:
associating the first campaign identifier with the first asset identifier; and
augmenting the tracking data for the first digital design asset upon each detected use of the first campaign identifier.

6. The method as recited in claim 1, wherein tracking usage of the first digital design asset in a plurality of marketing campaigns comprises identifying that the first digital design asset is used in the first marketing campaign via a plurality of marketing media.

7. The method as recited in claim 1, wherein the aggregated analytics data comprises a number of times that the digital design asset has been used in a marketing campaign from the plurality of marketing campaigns.

8. The method as recited in claim 1, wherein assigning asset identifiers to the digital design assets in the digital design asset repository comprises assigning a digital fingerprint to the digital design assets when the digital design assets are generated.

9. A method of analyzing performance of digital design assets for asset selection, comprising:
maintaining, by one or more servers, a digital design asset repository of a plurality of digital design assets available for use in marketing campaigns, the digital design assets comprising digital images, video files, or audio files;
assigning asset identifiers to the digital design assets in the digital design asset repository;
tracking interactions by one or more users with a first digital design asset used in a plurality of marketing campaigns;
aggregating, by the one or more servers, analytics data for the first digital design asset based on the tracked interactions with the first digital design asset; and
providing, by the one or more servers, the aggregated analytics data with the first digital design asset in the digital design asset repository.

10. The method as recited in claim 9, further comprising:
assigning a first campaign identifier to first marketing content comprising the first digital design asset;
tracking interactions with the first marketing content at a first marketing medium by identifying the first campaign identifier in connection with one or more user interactions with the first marketing content at the first marketing medium; and
tracking interactions with the first digital design asset in the first marketing campaign at the first marketing medium by identifying a first digital design asset identifier assigned to the first digital design asset in connection with the one or more user interactions with the first digital design asset at the first marketing medium.

11. The method as recited in claim 10, further comprising:
assigning a second campaign identifier to a second marketing content comprising the first digital design asset;
tracking interactions with the second marketing content at a second marketing medium by identifying the second campaign identifier in connection with one or more user interactions with the second marketing content at the second marketing medium; and
tracking interactions with the first digital design asset in the second marketing content at the second marketing medium by identifying the first digital design asset identifier assigned to the first digital design asset in connection with the one or more user interactions with the first digital design asset at the second marketing medium,
wherein aggregating analytics data for the first digital design asset comprises aggregating analytics data for the first digital design asset in connection with the first marketing content at the first marketing medium and the second marketing content at the second marketing medium.

12. The method as recited in claim 10, further comprising tracking interactions with a second digital design asset in the first marketing content at the first marketing medium by identifying a second digital design asset identifier assigned to the second digital design asset in connection with one or more user interactions with the second digital design asset at the first marketing medium.

13. The method as recited in claim 9, wherein the aggregated analytics data comprises a number of times that the one or more users have clicked on the first digital design asset, a number of advertisement conversions resulting from the tracked interactions with the first digital design asset, or a number of unique users that have interacted with the first digital design asset.

14. The method as recited in claim 9, further comprising:
providing a user interface including digital design assets of the plurality of digital design assets; and
including next to each digital design asset in the user interface an indication of aggregated analytics data for each digital design asset.

15. The method as recited in claim 14, wherein the indication comprises an icon for each marketing medium in which the digital design assets have been used based on the aggregated analytics data.

16. The method as recited in claim 9, wherein tracking interactions by one or more users with a first digital design asset used in the plurality of marketing campaigns comprises tracking:
a number of likes of a social advertisement including the first digital design asset;
a number of shares of the social advertisement including the first digital design asset;
a number of clicks on an email advertisement including the first digital design asset; or
a number of impressions of a web page including the first digital design asset.

17. The method as recited in claim 16, further comprising calculating an analytics score for the first digital design asset based on the aggregated analytics data.

18. The method of claim 16 wherein calculating the analytics score for the first digital design asset comprises calculating a campaign score for each marketing campaign in which use of the first digital design asset was tracked, multiplying each campaign score by a weight specific to the marketing campaign; and aggregating the weighted campaign scores.

19. The method as recited in claim 17, further comprising:
determining that the analytics score of the first digital design asset is above a predetermined score threshold;
identifying one or more characteristics of the first digital design asset; and
selecting, by the one or more servers, a second digital design asset having the one or more characteristics of the first digital design asset for use in a second marketing campaign.

20. A system for analyzing usage of digital design assets for asset selection, comprising:
at least one processor; and
at least one non-transitory computer-readable storage medium storing instructions thereon that, when executed by the at least one processor, cause the system to:
maintain a digital design asset repository of a plurality of digital design assets available for use in marketing campaigns, the digital design assets comprising digital images, video files, or audio files;
assign asset identifiers to the digital design assets in the digital design asset repository;
track usage of a first digital design asset in a plurality of marketing campaigns;
track interactions by one or more users with the first digital design asset in connection with a the plurality of marketing campaigns;
aggregate analytics data for the first digital design asset based on the tracked usage of the first digital design asset and the tracked interactions with the first digital design asset; and
provide the aggregated analytics data with the first digital design asset in the digital design asset repository.
